(19) United States
(12) Patent Application Publication
(10) Pub. No.: US 2011/0208570 A1
(43) Pub. Date: Aug. 25, 2011

(54) APPARATUS, SYSTEM, AND METHOD FOR INDIVIDUALIZED AND DYNAMIC ADVERTISEMENT IN CLOUD COMPUTING AND WEB APPLICATION

(76) Inventor: Dehai Kong, Cupertino, CA (US)

(21) Appl. No.: 13/033,600

(22) Filed: Feb. 23, 2011

Related U.S. Application Data
(60) Provisional application No. 61/307,454, filed on Feb. 24, 2010.

(51) Int. Cl. G06Q 30/00

(52) U.S. Cl. 705/14.5; 705/14.49; 705/14.53; 705/14.54; 705/14.73

(57) ABSTRACT

An apparatus, system, and method are disclosed for individualized and dynamic advertisements delivery and display in cloud computing and ordinary Internet systems. The client updates the advertisement server periodically the user web browsing history and local media, advertisements play back log. The client updates the advertisement server the user geographical location. The advertisement server analyzes the user interest and geographical information from client, combining with the server information of client neighborhood events, client neighboring friends, traffic, weather condition. The advertisement server selects the advertisements, tags the selected advertisements, then pushes to the client local storage. Client takes the retrieved web content and selects the best fit advertisements from local storage with according to the time, date, as well as the information of browsing history, geographical information, neighborhood events, client neighboring friends, traffic, weather. The client constructs new web pages with the individualized advertisements. The individualized advertisements can be added to the original web pages, or replace original advertisements.

This patent application claims the benefits of the provisional patent application with application No. 61/307,454, titled “Apparatus, system and method for Internet device architecture with unified processor, operation system and web browser”, filed on 02/24/2010.

### BACKGROUND OF THE INVENTION

The present invention is in the technical field of advertisement. More particularly, the present invention is in the technical field of advertisement in Internet and cloud computing.

The existing advertisement method on Internet, cloud computing and web application is through embedding the advertisements on web pages, or pop-ups. The web pages and advertisements are retrieved and displayed at their original format to all users without any distinguishing. The obvious disadvantage of the prior art web advertisement is that the advertisements may not target right person, thus the effectiveness of the advertisement is low. The targeting of the advertisements is not accurate, thus is not effective, since it does not consider the viewer's individual needs, it does not consider the viewer's current needs.

This patent application claims the priority benefit of the provisional patent application with application No. 61/307,454, titled “Apparatus, system and method for Internet device architecture with unified processor, operation system and web browser”, filed on Feb. 24, 2010.

Reference Cited:

U.S. Pat. Documents:

| | | | |
|---|---|---|---|
| 7,886,067 | Krassner, et al. | Feb. 8, 2011 | 709/231 |
| 7,856,358 | Ho | Dec. 21, 2010 | 704/270 |
| 7,725,464 | Grubb, et al. | May 25, 2010 | 707/723 |
| 7,386,470 | Joo | Jun. 10, 2008 | 705/14.61 |
| 6,912,504 | Rashkovskiy | Jun. 28, 2005 | 705/14.68 |
| 6,725,203 | Seet, et al. | Apr. 20, 2004 | 705/14.53 |
| 6,339,761 | Cottingham | Jan. 15, 2002 | 705/14.66 |
| 6,161,127 | Cezar, et al. | Dec. 12, 2000 | 709/203 |

Provisional Patent Application

| | | |
|---|---|---|
| 61307454 | Kong | Feb. 24, 2010 |

### OBJECTS AND SUMMARY OF THE INVENTION

The primary object of the present invention is to deliver individualized advertisements to users or viewers. The object is to select the specific advertisements for the user according to his/her Internet browsing habits of all the websites the user visited in a time span. Another object is to deliver the advertisements according to the user's current geographical location. Another object is to embed the advertisements in the user's webpage display without disturbing pop-ups and corrupted web pages. The individualized advertisements are implemented through a client-server scheme, where the advertisements server can be detached from the web server, and the client is responsible to assemble the advertisements and web pages according to certain statistics and control.

This individualized and dynamic cloud computing advertisements system comprises advertisements server, client software, and client hardware.

One advantage of the present invention is that the advertisements are individualized to each user for best effectiveness. The individualization includes the web surfing habits all over the internet, the local machine music, video watching and game play habit, and the geographical location, neighboring events, neighboring friends, weather, traffic.

Another advantage of the present invention that the dynamic advertisements system presents the best fit advertisements to the viewer with considering of time, date, geographical location, and neighborhood information.

Another advantage of the present invention that the individualized advertisements are embedded inside the webpage, music, video or game, without annoying pop-ups, corrupted web pages , etc.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings:

FIG. 1 is a drawing illustrating the current Internet advertisements model (prior art).

FIG. 2 is a drawing illustrating the advertisements delivery flow in the prior art advertisements model.

FIG. 3 is a drawing illustrating the individualized and dynamic cloud computing advertisements model of the present invention.

FIG. 4 is a drawing illustrating the mechanism of the individualized advertisements generation and delivery of the present invention.

FIG. 5 is a drawing illustrating the hardware block diagram of the advertisements targeting process of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

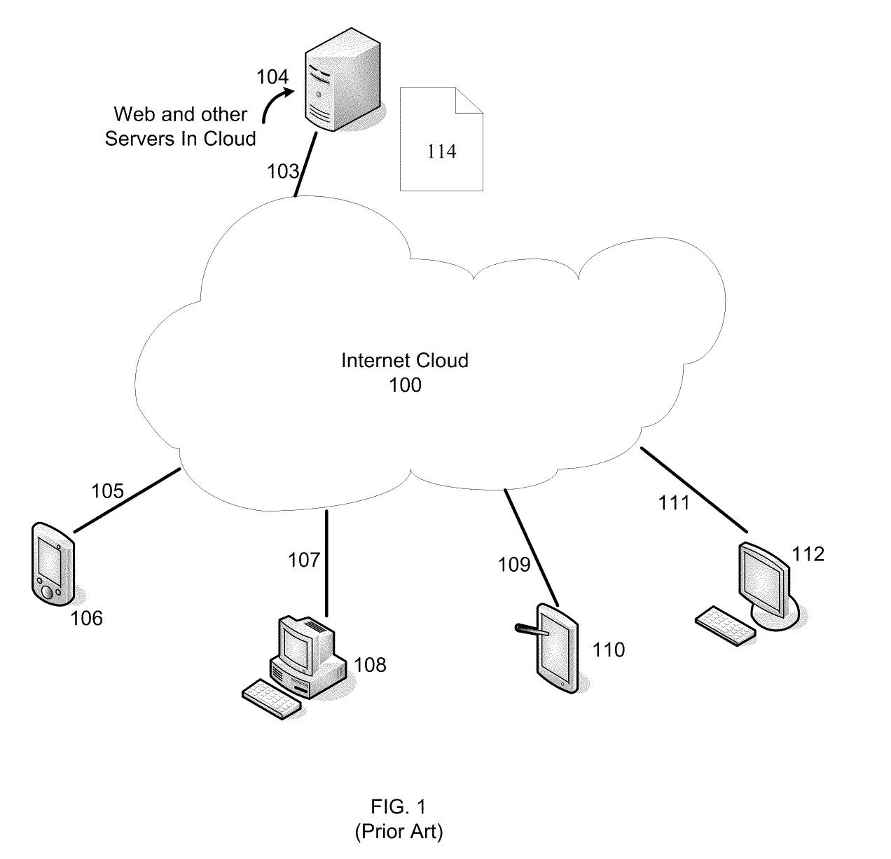

FIG. 1 depicts the architecture of the prior art Internet advertisement model. Advertisements are embedded in the web pages 114 user retrieves from the web server 104. When the client (a PC 108, notebook, smart phone 106, netbook, MID or others) sends a URL (universal Resource Locator) HTTP (Hyper Text Transport Protocol) request for the desired web pages, the request is sent through the Internet 100. When the HTTP request reaches the server 104, the server sends back the web pages 114 with embedded advertisements. The advertisements on the web pages are fixed and placed on certain places before the page 114 is delivered to the client. The same advertisements one the same web pages are delivered to many users, who may have different needs.

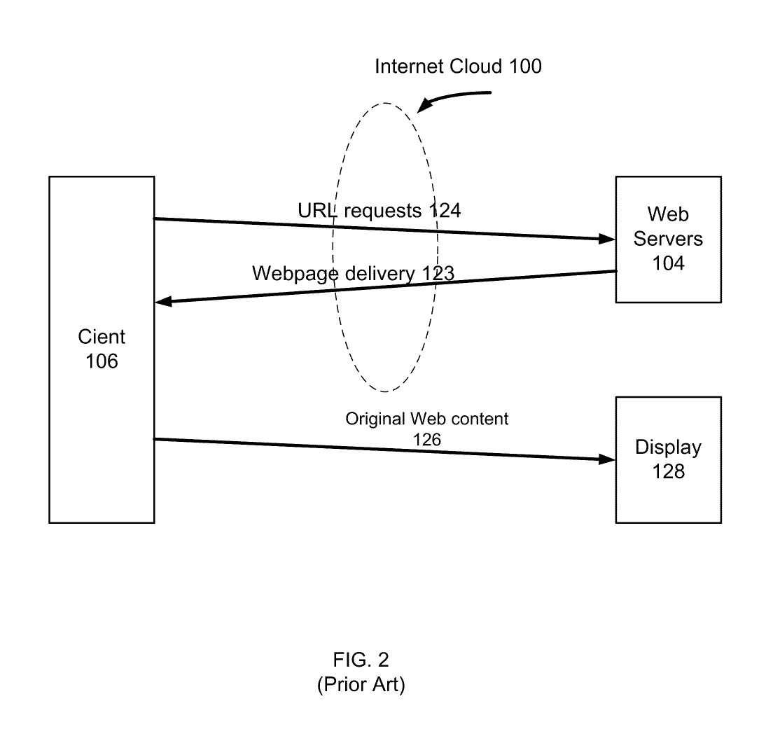

FIG. 2 depicts the advertisements delivery flow in the prior art advertisements model. Client 106 is the web browsing device. Path 124 indicated a user request 124 for one particular web page through Internet cloud 100. The web server 104 receives the request 124. Path 123 is the delivered web page content with the embedded advertisements. Path 126 indicates that the advertisements and web content are sent to display controller 128 and are displayed on screen.

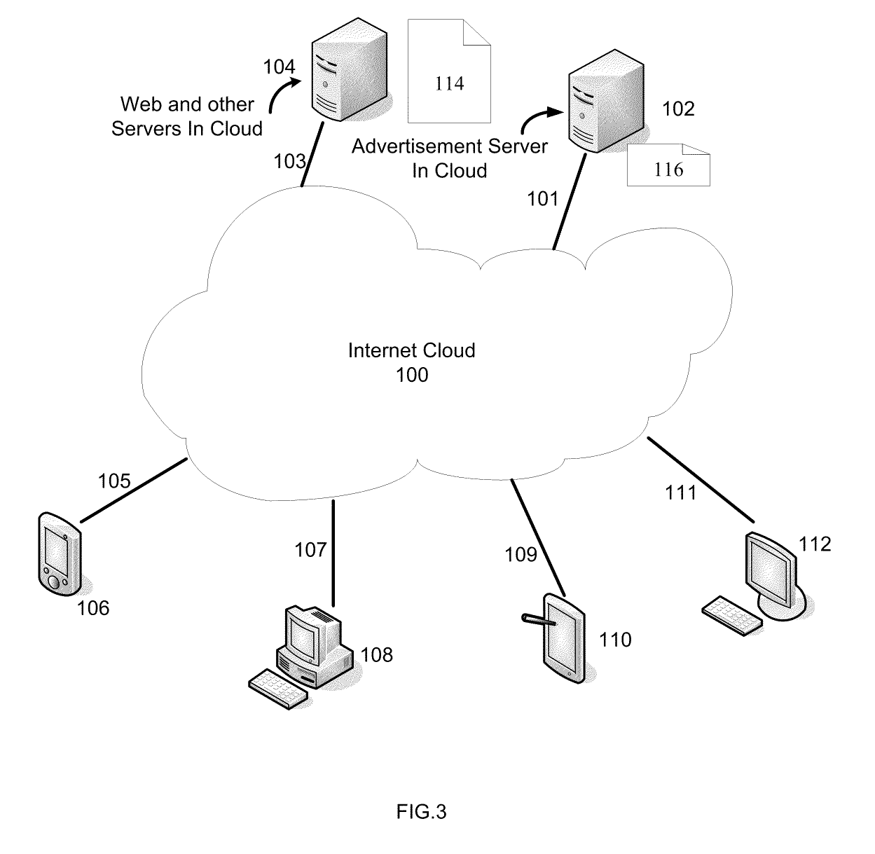

FIG. 3 depicts the architecture of the invented individualized and dynamic could computing advertisement model. Advertisements server 102 is placed in the cloud, in addition to prior art web server 104 and clients 106, 108, 110, 112. Multiple advertisements servers can be connected to the Internet in one location or different locations. The advertisements serves may not tied to specific content websites or servers.

In one embodiment, client 106 updates the advertisements server 102 with the client's browsing history as well as location information at certain time. When shall the client updates information to server is determined by client internal algorithm with consideration of location, time, and browsing history. The advertisement server 102 pushes advertisements 116 to the device at the best time based on the evaluation of the information received from the client 106. For example, if the user just arrives a new city, the new advertisements associated with the new city will be delivered to the client right away. The advertisements delivered to the client are also selected by the server according to the individual's browsing history and location as well as other parameters such as time of the day, nearby friends status, device information (battery life, etc.), weather, local events, traffic. The delivered advertisements 116 are stored in the client device.

When a URL HTTP request is sent to content server, the content serves in the cloud deliveries web content and advertisements as it is. When the client device receives the web pages, the client system analyzes the webpage content. Then the client system injects the targeted advertisements to the web pages before display the web pages. The final appearance of the constructed webpage is smooth and intuitive.

User can voluntarily start to search from locally stored advertisements even the device is not connected to the Internet.

The advertisements pushing channel can also be used to send emergency messages to the user and be displayed over the user's display screen. A alarm sound and recorded voice can also be played back.

The advertisements push channel can also be used to send instant alert of other events, such as stock market, messenger, from advertisement server to clients.

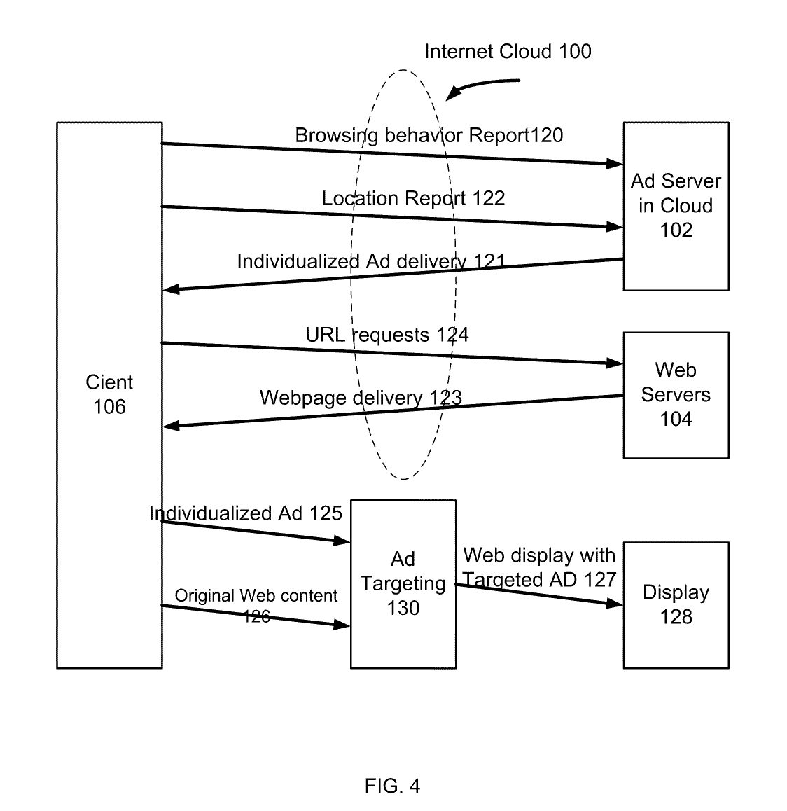

FIG. 4 depicts the traffic flow of the invented cloud computing advertisement model. Path 120 indicates that the client 106 sends user browsing history information and other behavior information to server 102. Other behavior information can include voluntary advertisements play back, mp3 song played, video clip played, ebook read etc. Path 122 sends user's location information to the server 102. Path 121 indicated the server pushes advertisements to the client periodically after receiving the client information and after analysis of the user's current and history information. Path 124 indicates a user's request 124 for one particular web page. The server 102 receives the request 124. Path 123 is the delivered web page content with the embedded advertisements which was pre-installed on the web pages. Path 126 indicates that the web content is send to advertisement targeting engine 130. The advertisements stored in the client 106 are selectively fetched by the path 125, then a compositing method combines the web content and the targeted advertisements. A display module 128 displays the new web content 127 with the targeted advertisements.

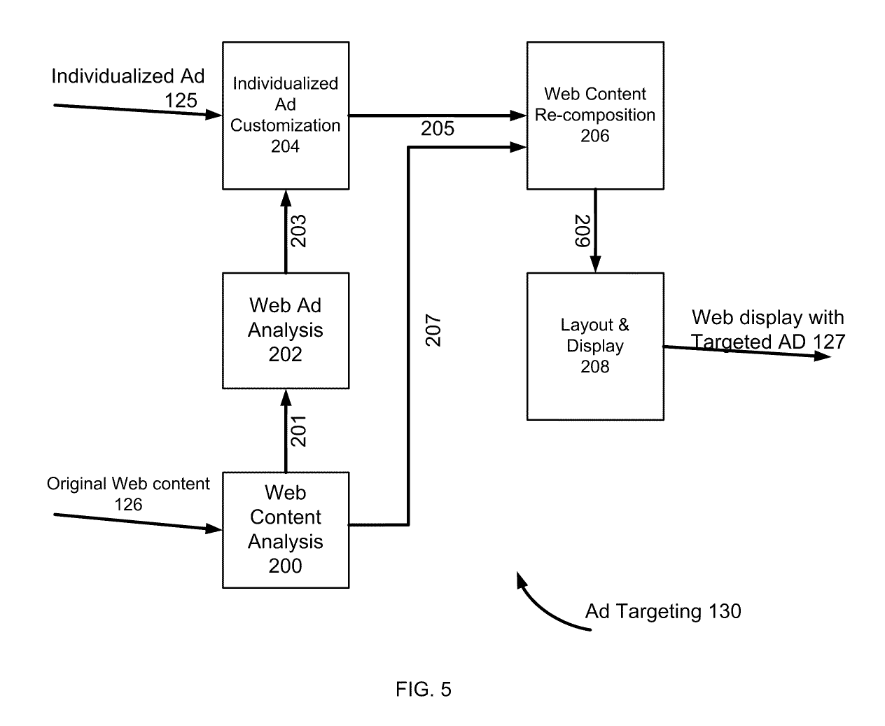

FIG. 5 is a drawing illustrating the hardware block diagram of the advertisements targeting process 130. The advertisements targeting engine comprises web content analysis 200, web advertisements analysis 202, advertisements customization 204, and layout 208. The hardwired integrated circuit takes input of original web content 126 and individualized advertisements 125 stored in the client. Web content analysis module 200 analyzes the objects of the web pages, identifies the property of the web content. The web advertisement analysis module 202 analyzes the advertisement content, and identifies the property of advertisement content. The properties include the location, size, animation etc. The advertisement customization module 204 customizes the size and appearance of the stored individualized advertisements 125. The customization includes resizing, color changing, blending, time line for animation. Web content re-composition module takes the output of 204 and 200, composites the re-constructed web pages with the original web content and newly added individualized advertisements and pass to layout module 208. Layout module 208 put the re-constructed web page 209 to the right position of the display frame buffer. Display module displays the final content 127.

The final content 127 can have original web content, original web advertisements, individualized advertisements.

### ALTERNATIVE EMBODIMENTS

Reference throughout this specification to “one embodiment,” “an embodiment,” or similar language means that a particular feature, structure, or characteristic described in connection.

One alternative embodiment is a networked advertisement delivering and display system in a closed network, where advertisement server, client software and hardware use the advertisement individualizing method of present invention to deliver targeted advertisements to the users.

One alternative embodiment is a system using the server, client software and hardware apparatus of present invention to deliver other individualizing information, including weather, traffic, restaurants to the users.

Another alternative embodiment is an advertisement system with only some of the advertisement servers, client software and hardware to deliver individualized and dynamic advertisement to the users.

What is claimed is:

1. An apparatus to Internet advertisement, the apparatus comprising:
(a) Advertisement servers.
(b) Client individualized and dynamic advertisement software.
(c) Client advertisement construction hardware.

2. The apparatus of claim 1, (a) advertisement server prepares individualized advertisement, pushes to the client local storage with tags. Client software (b) and client hardware (c) take the retrieved web content and select the best advertisements from local storage, to construct a new web page with the individualized advertisements. The advertisements system is also dynamic, the advertisements selection can change when time, date, neighborhood event, neighboring friends, weather, traffic change.

3. The apparatus of claim 1, wherein the (a) advertisement server, monitors the incoming client analyzes user data, makes decisions on choosing the specific advertisements. Then the advertisement server pushes the selected advertisements to the client device. The server decision making of advertisement selecting can be automatic. The server decision making of advertisement selecting can also be controlled by manually inputs.

4. The apparatus of claim 1, wherein the (a) advertisement server, advertisement tag organizes the advertisements to categories according to the geographical information, interest fields, weather, traffic, neighborhood events, neighborhood status, etc. Then the tagged advertisements are packetized to a format that the client device understand and expecting.

5. The apparatus of claim 1, wherein the (a) advertisement server, in case of emergency, the special warning messages are pushed to user client device and displayed on screen.

6. The apparatus of claim 1, advertisements are designed using vector graphics, the objects, animations are all vector based, and parameterized.

7. The apparatus of claim 2, the user information update history is kept in the advertisement server and used for analyzing user's interest for defined time range. The life time of the stored history and the time ranged used to analyze the user's browsing behavior are defined according to software algorithm and defined rules.

8. The apparatus of claim 2, wherein the advertisement server, a database or database system is maintained, with the record of advertisements played, clicked, merchandise purchased, places visited.

9. The apparatus of claim 1, wherein the (b) client, individualized and dynamic advertisement software, the software monitors user web surfing, music, video, game playing habits. The software analyzes the collected user interest and habits using special model, and concludes the user habits. The concluded use habits are encoded to a short index, and sent to the advertisement server

10. The apparatus of claim 1, wherein the (b) client individualized and dynamic advertisement software, manages the advertisements, make the advertisement searching and advertisement injection efficient, monitors geographical information, monitors weather and traffic information

11. The apparatus of claim 1, wherein the (b) client individualized and dynamic advertisement software, advertisements can be played back without an Internet connection.

12. The apparatus of claim 1, wherein the (c) client advertisement construction hardware, web contents are further analyzed and categorized. Based on the property of the web pages, targeted advertisements are injected to the web, with proper size, location, boarders.

13. The apparatus of claim 1, wherein the (c) client advertisement construction hardware, advertisement injection is done by hardware, so software, CPU (central processor unit) may not be involved.

14. The apparatus of claim 1, wherein the (c) client advertisement construction hardware, the advertisement can also be pre-installed on the client devices.

15. The apparatus of claim 1, wherein the (c) client advertisement construction hardware, in the case of missing connection to the Internet, the client device provides offline advertisements playback with user habits info and location and other parameters.

16. The apparatus of claim 1, where in the (c) client the individualized advertisements can also be played back independently without retrieving anything from the Internet

17. The apparatus of claim 1, wherein the (c) client advertisement construction hardware, the individualized advertisements can also be displayed as a overlay on webpage content if so chosen

18. The apparatus of claim 1, wherein the (c) client advertisement construction hardware, the advertisements can be inside web pages , inside of music files, inside of video clips, inside of game plays. The client can replace advertisements inside video, game and mp3 contented in the web pages with the individualized advertisements.

19. The apparatus of claim 1, wherein the (c) client advertisement construction hardware, the client can be an advertisements display monitors on a building wall, in side of elevators, in a train, on the outside wall of a building. The client can be a TV, HDTV with web connectivity, portable media player, GPS, MDTV (Mobile Digital TV)

20. The apparatus of claim 1, the client side can use software only approach to construct the advertisements injected content without special hardware support.
